(19) United States
(12) Patent Application Publication
(10) Pub. No.: US 2008/0158372 A1
(43) Pub. Date: Jul. 3, 2008

(54) ANTI-ALIASING IN AN IMAGING DEVICE USING AN IMAGE STABILIZATION SYSTEM

(76) Inventors: Russell J. Palum, Rochester, NY (US); John D. Griffith, Rochester, NY (US)

Correspondence Address: Frank Pincelli;Patent Legal Staff, Eastman Kodak Company, 343 State Street, Rochester, NY, 14650-2201, US

(21) Appl. No.: 11/616,368

(22) Filed: Dec. 27, 2006

(51) Int. Cl. H04N 5/228; H04N 5/225

(52) U.S. Cl. 348/208.99; 348/332; 348/220.1; 348/E03.012; 348/E05.031

(57) ABSTRACT

An imaging device for generating a digital image of a scene comprises an image sensor, an optic, and one or more actuators. The image sensor comprises an array of photosensors. The optic is operative to at least partially direct light rays from the scene onto this image sensor so that an image of the scene is created on the image sensor. The one or more actuators are operative to move at least one of the image sensor and the optic while the digital image is generated so that the incoming light rays from the scene are distributed over the photosensors of the image sensor in such a way as to limit spatial frequencies in the image of the scene created on the image sensor to values below a Nyquist frequency of the image sensor.

### FIELD OF THE INVENTION

The present invention relates generally to digital imaging devices, and, more particularly, to anti-aliasing in imaging devices that utilize image stabilization systems.

### BACKGROUND OF THE INVENTION

Modern digital cameras frequently contain a host of different features that serve to improve the quality of generated digital images. One such feature is an image stabilization system, such as that found on the Kodak EasyShare® P712 Zoom Digital Camera. When taking a photograph with a digital camera, a photographer will frequently inadvertently move the digital camera during an exposure. This movement introduces relative motion between the scene being imaged and the image sensor within the digital camera. When the exposure is relatively short and the motion is small, the digital image will typically not be degraded to any great extent. However, if the exposure is relatively long or the motion is more extreme, the digital image may become undesirably blurred. An image stabilization system serves the purpose of reducing the relative motion between the image of the scene directed onto the image sensor and the image sensor itself due to movement of the digital camera. In some cases, the image stabilization system mechanically moves a lens or other optic within the digital camera to compensate for the relative motion of the scene. In other configurations, an image stabilization system may move the camera's image sensor in such a way as to produce the same effect.

In addition to image stabilization systems, modern digital cameras also frequently contain anti-aliasing systems. An anti-aliasing system addresses artifacts caused by a digital camera's digital sampling and reconstruction of a scene. These aliasing artifacts may severely reduce the quality of a digital image. A digital camera is prone to aliasing unless the content of the scene is limited to one half of the spatial sampling frequency of the digital camera's image sensor (i.e., the Nyquist frequency of the image sensor). If, for example, the digital camera's image sensor samples 500 samples per millimeter, the spatial frequency of the scene content is limited to 250 samples per millimeter. This limiting is usually accomplished with anti-aliasing spatial filters (sometimes also called blur filters or AA filters). These filters may use birefringence, diffraction or refraction to limit the spatial frequency of the scene content to one-half of the sampling frequency of the digital camera's image sensor. The spatial frequency of the scene content is limited by enlarging (i.e., blurring) the camera lens's single-spot point spread function or by converting the point spread function spot to two or more discrete spots with spaces between them. The most common anti-aliasing filter comprises several quartz plates and acts to convert a single-spot point spread function of the lens into four discrete spots at the corners of a square. The center-to-center distance between the four spots is usually chosen to be equal to the pitch of the photosensors on the camera's image sensor, although other values may also be effective.

Issues of image stabilization and aliasing have conventionally been addressed by equipping a digital camera with separate image stabilization and anti-aliasing systems. However, if just one system could be made to perform both functions, the cost of manufacturing a digital camera could be substantially reduced.

### SUMMARY OF THE INVENTION

Embodiments of the present invention address the above-identified need by providing methods and apparatus for performing image stabilization and anti-aliasing functions in a digital imaging device without requiring separate image stabilization and anti-aliasing systems.

In accordance with an aspect of the invention, an imaging device for generating a digital image of a scene comprises an image sensor, an optic, and one or more actuators. The image sensor comprises an array of photosensors. The optic is operative to at least partially direct light rays from the scene onto this image sensor so that an image of the scene is created on the image sensor. The one or more actuators are operative to move at least one of the image sensor and the optic while the digital image is generated so that the incoming light rays from the scene are distributed over the photosensors of the image sensor in such a way as to limit spatial frequencies in the image of the scene created on the image sensor to values below a Nyquist frequency of the image sensor.

In one of the above-identified embodiments, a digital camera comprises a lens, an image sensor and a lens actuation module. The lens actuation module, moreover, comprises inertial sensors and lens actuators. Command signals are fed to the lens actuators to cause the lens actuators to move the lens in two dimensions. The command signals comprise two components. An image stabilization component of the command signals causes the lens to be moved in a manner opposite to the movement of the image sensor relative to the scene. An additional anti-aliasing component causes the lens to be moved so as to distribute the scene content over the image sensor in a fixed pattern during an exposure. The distribution of the scene content over the image sensor is designed to reduce spatial frequencies in the scene content below the Nyquist frequency of the image sensor. In this way, the lens actuation module is operative to perform both image stabilization and anti-aliasing functions within the digital camera. An advantageous reduction in the cost and complexity of the digital camera is thereby achieved.

These and other features and advantages of the present invention will become apparent from the following detailed description which is to be read in conjunction with the accompanying drawings.

### BRIEF DESCRIPTION OF THE DRAWINGS

FIG. 1 shows a block diagram of a digital camera in accordance with an illustrative embodiment of the invention;

FIG. 2 shows a block diagram of the lens actuation module in the FIG. 1 digital camera;

FIG. 3 shows a schematic representation of how the lens actuators in the FIG. 2 lens actuation module act on the lens in the FIG. 1 digital camera;

FIG. 4 shows a first set of image stabilization and anti-aliasing command signals for the FIG. 2 lens actuation module; and

FIG. 5 shows a second set of image stabilization and anti-aliasing command signals for the FIG. 2 lens actuation module.

### DETAILED DESCRIPTION OF THE INVENTION

The present invention will be described with reference to illustrative embodiments. It is appreciated that numerous modifications can be made to these embodiments and the results will still come within the scope of the invention. No limitations with respect to the specific embodiments described herein are intended or should be inferred.

The invention may be implemented in a variety of different types of digital imaging devices including, for example, a digital still camera, digital video camera, or a combination thereof. The digital camera may be combined with another device such as a mobile telephone, personal digital assistant (PDA) or wireless electronic mail device.

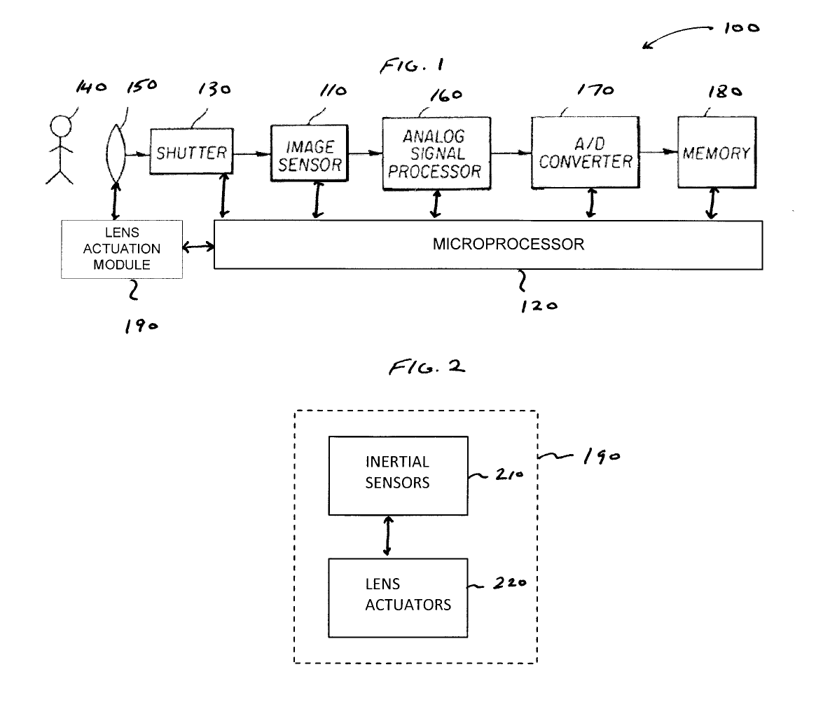

FIG. 1 shows a digital camera 100 in accordance with an illustrative embodiment of the invention. The digital camera includes an image sensor 110 which includes a two-dimensional array of photosensors corresponding to picture elements (pixels) of the image. The image sensor can include, for example, a charge-coupled device (CCD) or a complementary metal-oxide-semiconductor (CMOS) imager. The pixels of the image sensor are preferably covered by a conventional Bayer-type color filter to form a red-green-blue (RGB) color filter array (CFA). An image is captured under the control of a microprocessor 120 which causes a shutter 130 to open and light rays from a scene 140 to be directed by a lens 150 onto the image sensor. When the image sensor is exposed to the light rays from the scene, analog image charge is produced in the photosensors. After the shutter is closed, the charge information produced by the image sensor is transmitted to an analog signal processor 160. The analog signal processor converts the received charge information to analog image signals corresponding to respective photosensors on the image sensor. The analog image signals from the analog signal processor are then sent to an analog-to-digital (A/D) converter 170 which generates a digital signal value for each photosensor from the analog input signals. The captured digital image signals are stored in a memory 180.

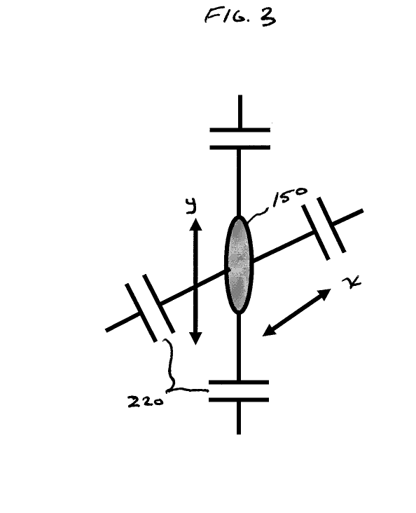

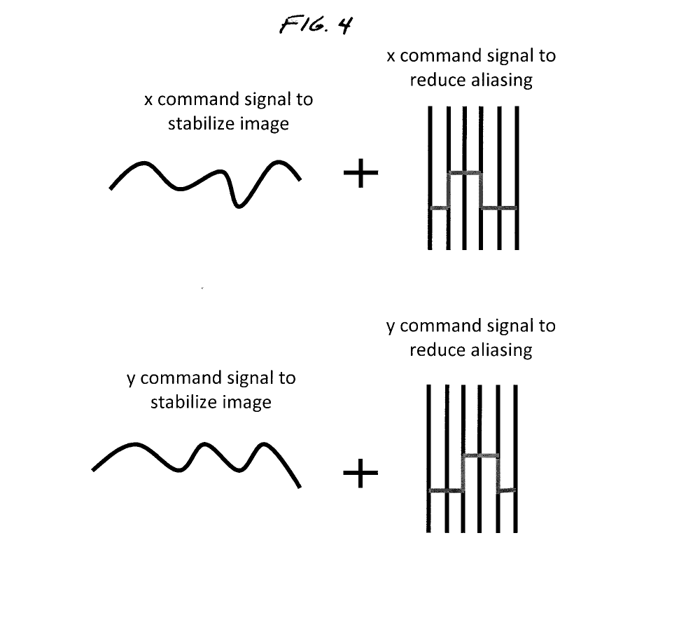

The digital camera 100 further includes a lens actuation module 190. As indicated in the block diagram in FIG. 2, the lens actuation module includes inertial sensors 210 and lens actuators 220. The lens actuators, in turn, are coupled to the lens 150 in the manner indicated in FIG. 3. The lens actuators are able to simultaneously translate the lens in both the x and y directions, as indicated in the figure.

The lens 150 may be viewed as an example of what is more generally referred to herein as an “optic.” It should be noted that the term “optic” as used herein is intended to be broadly construed so as to also encompass other types of optical elements, as well as combinations of such elements, e.g., an optical assembly including multiple lenses or other types of optical elements.

Inertial sensors and lens actuators are utilized in conventional image stabilization systems in digital cameras and, as a result, their implementation and operation will be familiar to one skilled in the art. Typically, the inertial sensors include two small gyroscopes that precess as the digital camera moves. These small gyroscopes send command signals to the lens actuators which typically include a set of servomotors. The gyroscopes signal the servomotors to move the lens in a direction opposite to the movement of the digital camera. Image stabilization may help a photographer take photographs without substantial blur that have longer exposure times or higher zoom settings than photographs taken without the use of image stabilization.

Advantageously, the lens actuation module 190 is operative to perform both image stabilization and anti-aliasing functions within the digital camera 100. Image stabilization is largely performed in the conventional manner. During an exposure, command signals from the inertial sensors 210 are sent to the lens actuators 220 in order to cause the lens actuators to move the lens 150 in a direction opposite to any movement of the digital camera itself. Relative motion between the image sensor 110 and the image of the scene impinging on the image sensor is thereby reduced. Simultaneously, the lens actuators are further commanded through additional command signals generated by the microprocessor 120 to move in a fixed pattern which substantially reduces or eliminates aliasing, as will be described in greater detail below. The lens actuation module thereby accomplishes both functions with a single system, eliminating the need for separate image stabilization and anti-aliasing systems.

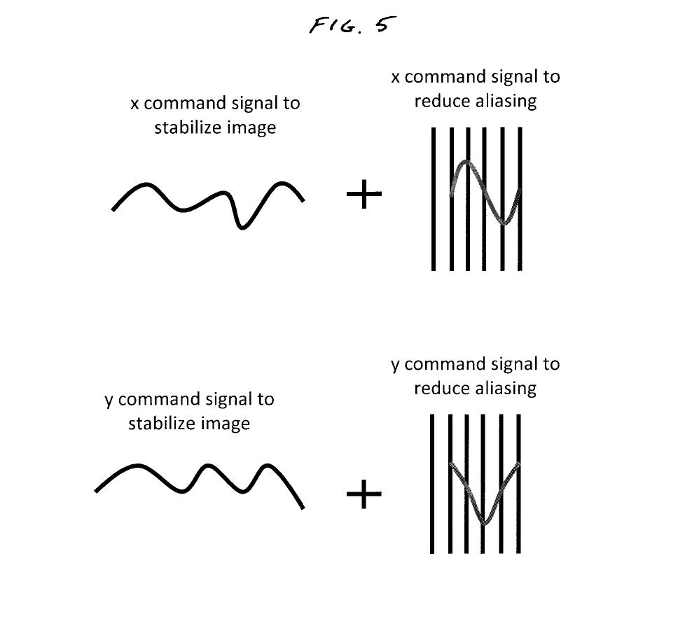

FIG. 4 illustrates how command signals from the inertial sensors 210 and the microprocessor 120 may be combined to cause the lens actuation module 190 to perform both image stabilization and anti-aliasing functions. The upper set of command signals causes the lens actuators 220 to move the lens 150 in the x-direction while the lower set of command signals causes the lens to be moved in the y-direction. Within each set of command signals, the leftmost command signals are directed at image stabilization. These command signals are responsive to camera motion occurring during a particular exposure. They would therefore be expected to change form from exposure to exposure. The rightmost signals, in contrast, are directed at anti-aliasing. The rightmost command signals cause the lens actuators to move the lens in a fixed pattern during each exposure.

In the particular embodiment shown in FIG. 4, the rightmost, anti-aliasing command signals cause the lens actuators 220 to move the lens 150 during a given exposure such that light rays from a given point in the scene 140 are distributed over four discrete regions on the image sensor 110. These discrete regions on the image sensor describe the four corners of a square and are preferably separated by a space equal to about the pitch of the photosensors on the image sensor, although other spacing may be similarly effective. Distributing light rays from the scene in this way acts to slightly blur the scene content impinging on the image sensor due to the integrating function of the image sensor. Blurring the light waves impinging on the image sensor has the effect of limiting the maximum spatial frequency of the scene content. In other words, high spatial frequency scene content is blurred so that the high spatial frequency content is effectively eliminated.

In this way, the lens actuation module 190 acts to limit the spatial frequency of scene content impinging on the image sensor 110 in a manner similar to that of a conventional anti-aliasing filter such as a four-spot birefringent blur filter. By making the point spread function of the scene content larger, the spatial frequency of the scene content can easily be limited below the Nyquist frequency (i.e., one-half the sampling frequency) of the image sensor. The lens actuation module thereby reduces or eliminates aliasing while simultaneously providing image stabilization.

While the anti-aliasing command signals in FIG. 4 act to move the lens 150 to four discrete positions, the invention is not limited to this particular fixed pattern. Instead, the lens actuation module 190 can be programmed to distribute light waves from the scene over the image sensor 110 in numerous other patterns and the result will still come within the scope of the invention. These different patterns may be accomplished by merely changing the form of anti-aliasing command signals fed to the lens actuators 220. FIG. 5, for example, shows command signals that cause light rays from a given point in the scene 140 to describe substantially a circle over the image sensor. The command signals may in a similar way be adapted to form other shapes such as a triangle, a square or a rectangle. Advantageously, the ability to change the manner in which the lens distributes light rays from the scene over the image sensor allows the lens actuation module to synthesize any point spread function or any desired frequency band pass for the image sensor while at the same time providing image stabilization for the digital camera 100.

To further advantage, the lens actuation module 190 may be made to limit the scene content to different spatial frequency values based on a system mode. Modern digital still cameras frequently have sub-sampling and video modes where the sampling frequency of the image sensor is reduced. Because of the ability to dynamically change the pattern of scene content impinging on the image sensor 110, the lens actuation module 190 may be configured to adjust the spatial frequency of the scene content below the particular Nyquist frequency of the digital camera 100 at any given time.

In FIG. 1, the lens actuation module 190 is operative to move the lens 150 in order to perform its various image stabilization and anti-aliasing functions. It is noted, however, that the same functions may be accomplished in a similar manner by moving the image sensor 110 itself and leaving the lens fixed. Many modern digital cameras move their image sensor instead of their lens in performing conventional image stabilization functions. One skilled in the art would recognize how to modify the above-described embodiment to accomplish image stabilization and anti-aliasing functions in accordance with aspects of the invention by using actuators to move the image sensor instead of moving the lens.

The invention has been described with reference to illustrative embodiments. However, it will be appreciated that variations and modifications can be effected by a person of ordinary skill in the art without departing from the scope of the invention.

### Parts List

100 digital camera
110 image sensor
120 microprocessor
130 shutter
140 scene
150 lens
160 analog signal processor
170 analog-to-digital (A/D) converter
180 memory
190 lens actuation module
210 inertial sensors
220 lens actuators

What is claimed is:

1. An imaging device for generating a digital image of a scene, the imaging device comprising:
an image sensor, the image sensor comprising an array of photosensors;
an optic, the optic operative to at least partially direct incoming light rays from the scene onto the image sensor so that an image of the scene is created on the image sensor; and
one or more actuators, the one or more actuators adapted to move at least one of the image sensor and the optic while the digital image is generated so that the incoming light rays from the scene are distributed over the photosensors of the image sensor in such a way as to limit spatial frequencies in the image of the scene created on the image sensor to values below a Nyquist frequency of the image sensor.

2. The imaging device of claim 1, wherein the imaging device comprises at least one of a digital still camera and a digital video camera.

3. The imaging device of claim 1, wherein the one or more actuators are adapted to move the image sensor.

4. The imaging device of claim 1, wherein the one or more actuators are adapted to move the optic.

5. The imaging device of claim 1, wherein at least one of the one or more actuators comprises a servomotor.

6. The imaging device of claim 1, wherein the one or more actuators are adapted to cause incoming light rays from a given point in the scene to be distributed over two or more discrete regions on the image sensor.

7. The imaging device of claim 1, wherein the one or more actuators are adapted to cause incoming light rays from a given point in the scene to be distributed over four discrete regions on the image sensor.

8. The imaging device of claim 7, wherein the four discrete regions are substantially located at four corners of a square.

9. The imaging device of claim 1, wherein the one or more actuators are adapted to cause incoming light rays from a given point in the scene to be distributed over a substantially continuous region on the image sensor.

10. The imaging device of claim 1, wherein the substantially continuous region defines substantially a circle on the image sensor.

11. The imaging device of claim 1, wherein the substantially continuous region defines substantially a triangle, a square or a rectangle on the image sensor.

12. The imaging device of claim 1, wherein the image sensor may be operated in more than one sampling mode, each mode having a different Nyquist frequency.

13. A method of reducing aliasing in an imaging device when generating a digital image of a scene, the imaging device comprising an image sensor comprising an array of photosensors and an optic operative to at least partially direct light from the scene onto the image sensor so that an image of the scene is created on the image sensor, wherein the method comprises moving at least one of the image sensor and the optic such that the incoming light rays from the scene are distributed over the photosensors of the image sensor in such a way as to limit spatial frequencies in the image of the scene created on the image sensor to values below a Nyquist frequency of the image sensor.

14. The method of claim 13, wherein the at least one of the image sensor and the optic are moved such that incoming light rays from a given point in the scene are distributed over two or more discrete regions on the image sensor.

15. The method of claim 13, wherein the at least one of the image sensor and the optic are moved such that incoming light rays from a given point in the scene are distributed over a substantially continuous region on the image sensor.

16. An imaging device for generating a digital image of a scene, the imaging device comprising:
an image sensor, the image sensor comprising an array of photosensors;
an optic, the optic operative to at least partially direct incoming light rays from the scene onto the image sensor so that an image of the scene is created on the image sensor;
one or more inertial sensors, the one or more inertial sensors operative to detect relative motion between the image of the scene created on the image sensor and the image sensor; and
one or more actuators;
wherein the one or more actuators are operative to move at least one of the image sensor and the optic while the digital image is generated in a direction opposite to any detected relative motion between the image of the scene created on the image sensor and the image sensor;
wherein the one or more actuators are further operative to move at least one of the image sensor and the optic while the digital image is generated so that the incoming light rays from the scene are distributed over the photosensors of the image sensor in such a way as to limit spatial frequencies in the image of the scene created on the image sensor to values below a Nyquist frequency of the image sensor.

17. The imaging device of claim 16, wherein at least one of the one or more inertial sensors comprises a gyroscope.

18. The imaging device of claim 16, wherein the one or more actuators move the at least one of the image sensor and the optic at least partially in response to a command signal, the command signal comprising:
a first command signal component, the first command signal component operative to cause the one or more actuators to move the at least one of the image sensor and the optic in a direction opposite to any detected relative motion between the image of the scene created on the image sensor and the image sensor; and
a second command signal component, the second command signal component operative to cause the one or more actuators to move the at least one of the image sensor and the optic so that the incoming light rays from the scene are distributed over the photosensors of the image sensor in such a way as to limit spatial frequencies in the image of the scene created on the image sensor to values below a Nyquist frequency of the image sensor.

19. The imaging device of claim 16, wherein the one or more actuators are adapted to cause incoming light rays from a given point in the scene to be distributed over two or more discrete regions on the image sensor.

20. The imaging device of claim 16, wherein the one or more actuators are adapted to cause incoming light rays from a given point in the scene to be distributed over a substantially continuous region on the image sensor.
